(19) United States
(12) Patent Application Publication
(10) Pub. No.: US 2015/0070300 A1
(43) Pub. Date: Mar. 12, 2015

(54) TOUCH CONTROL APPARATUS, CONTROLLER USED IN THE TOUCH CONTROL APPARATUS, AND THE CONTROL METHOD THEREOF

(71) Applicant: PixArt Imaging Inc., Hsin-Chu City (TW)

(72) Inventor: Chi-Chieh Liao, Hsin-Chu City (TW)

(73) Assignee: PixArt Imaging Inc., Hsin-Chu City (TW)

(21) Appl. No.: 14/201,951

(22) Filed: Mar. 10, 2014

(30) Foreign Application Priority Data
Sep. 10, 2013 (TW) 102132638

(51) Int. Cl. G06F 3/044

(52) U.S. Cl. CPC G06F 3/044
USPC 345/174

(57) ABSTRACT

A touch control apparatus comprises a capacitive panel and a controller. The capacitive panel comprises a first capacitive sensing area and a second capacitive sensing area. The first capacitive sensing area is used for touch control detection, and the second capacitive sensing area is used for proximity detection rather than the touch control detection. The controller is coupled to the capacitive panel and used for respectively control the first and second capacitive sensing areas to perform the touch control detection and the proximity detection.

### BACKGROUND OF THE INVENTION

1. Field of the Invention

The present invention relates to a touch control scheme, and more particularly to a touch control apparatus, a controller used in the touch control apparatus, and a corresponding controlling method.

2. Description of the Prior Art

Generally speaking, a conventional proximity detection employed by a conventional electronic device is implemented by using an infrared ray (IR) sensor for detection. Through emitting an IR signal and comparing the emitted IR signal with a reflected signal that is received, the conventional electronic device may estimate the distance of an object at the front so as to detect whether a user approaches the electronic device. However, an inevitable disadvantage is introduced by the IR sensor described above. For example, if the conventional electronic device is a portable device, it is necessary for the electronic device to dispose an IR emitter on the surface of electronic device. This would increase the whole size of the electronic device (i.e. the portable device). In addition, this also causes the conventional electronic device become not attractive. Further, for the IR sensor, it is necessary to drive a light-emitting diode to emit infrared ray, and accordingly more power would be consumed and circuit costs are increased equivalently.

### SUMMARY OF THE INVENTION

Therefore one of the objectives of the present invention is to provide a touch control apparatus, a controller used in the touch control apparatus, and a corresponding controlling method, to solve the above-mentioned problems. Through using different sensing areas of a capacitive panel of the touch control apparatus to respectively perform touch control detection and proximity detection and using a single controller to concurrently control both the operations of touch control detection and proximity detection, it is not required for the touch control apparatus to use an additional IR detector, and accordingly this can avoid the problems introduced by a conventional IR detector.

According an embodiment of the present invention, a touch control apparatus is disclosed. The touch control apparatus comprises a capacitive panel and a controller. The capacitive panel comprises a first capacitive sensing area and a second capacitive sensing area. The first capacitive sensing area is used for performing touch control detection. The second capacitive sensing area is used for performing proximity detection, rather than performing the touch control detection. The controller is coupled to the capacitive panel and is used for respectively controlling the first capacitive sensing area to perform the touch control detection and controlling the second capacitive sensing area to perform the proximity detection.

According to an embodiment of the present invention, a controller used in a touch control apparatus is disclosed. The touch control apparatus includes a capacitive panel which includes a first capacitive sensing area and a second capacitive sensing area. The first capacitive sensing area is used for performing a touch control detection, and the second capacitive sensing area is used for a proximity detection rather than performing the touch control detection. The controller comprises a touch control detection circuit and a proximity detection circuit. The touch control detection circuit is used for performing the first capacitive sensing area to execute the touch control detection, and the proximity detection circuit is coupled to the touch control detection circuit and used for controlling the second capacitive sensing area to execute the proximity detection.

According to an embodiment of the present invention, a controlling method used in a touch control apparatus is disclosed. The touch control apparatus includes a capacitive panel which includes a first capacitive sensing area and a second capacitive sensing area. The first capacitive sensing area is used for performing a touch control detection, and the second capacitive sensing area is used for a proximity detection rather than performing the touch control detection. The controlling method comprises: performing a touch control detection to control the first capacitive sensing area to execute the touch control detection; and performing a proximity detection to control the second capacitive sensing area to execute the proximity detection.

According an embodiment of the present invention, by using the second capacitive sensing area to perform the proximity detection (the second capacitive sensing area is electrically isolated from a capacitance sensing area which is employed for touch control detection), it is not required for the touch control apparatus to use an additional proximity detector to perform the proximity detection. For instance, it is not required for the touch control apparatus to use an additional IR proximity detector. Accordingly, this can reduce the whole size of the portable device. In addition, since it is not required to drive an LED to emit infrared ray, more power can saved correspondingly. In addition, it is not required for the touch control apparatus to configure an IR light emitting hole for the conventional IR proximity detector, and thus the appearance of touch control apparatus becomes more attractive.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a touch control apparatus according to a first embodiment of the present invention.

FIG. 2A is a signal diagram illustrating a case which the touch control detection circuit as shown in FIG. 1 uses a self-capacitance sense calculation and the proximity detection circuit executes the proximity detection.

FIG. 2B is a signal diagram illustrating a case which the touch control detection circuit as shown in FIG. 1 uses a mutual-capacitance sense calculation and the proximity detection circuit executes the proximity detection.

FIG. 3A is a diagram of a touch control apparatus according to a second embodiment of the present invention.

FIG. 3B is a diagram of a touch control apparatus according to a third embodiment of the present invention.

### DETAILED DESCRIPTION

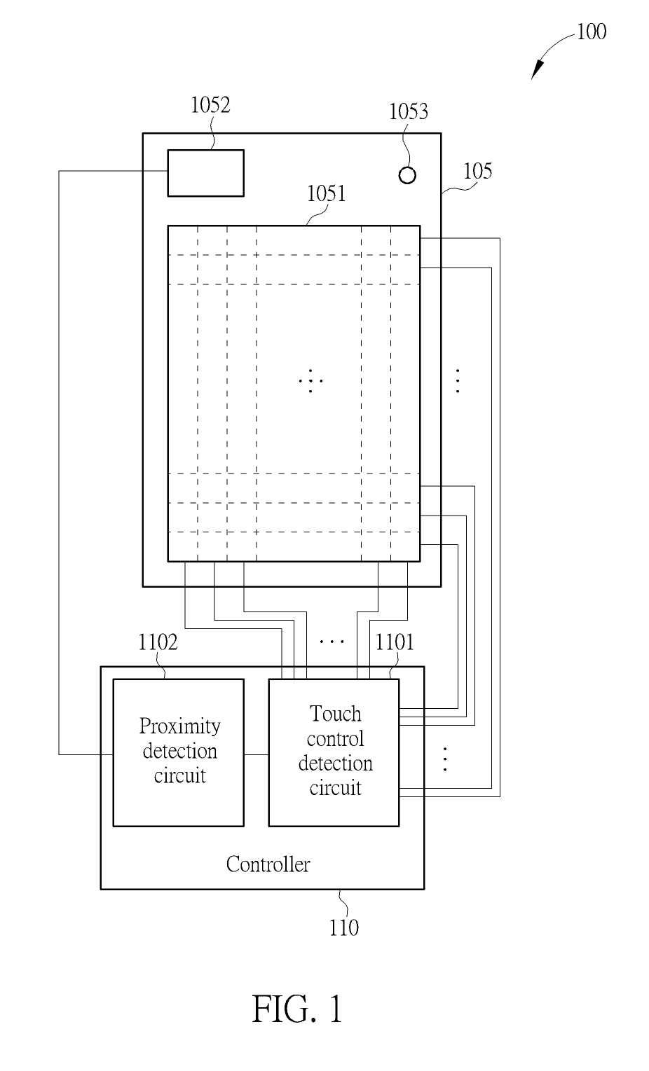

Please refer to FIG. 1, which is a diagram of a touch control apparatus 100 according to a first embodiment of the present invention. The touch control apparatus 100 comprises a capacitive panel 105 such as a projective capacitive panel and a controller 110. The projective capacitive panel 105 comprises a first capacitive sensing area 1051 and a second capacitive sensing area 1052. The first capacitive sensing area 1051 preferably (but not limited) is electrically isolated from the second capacitive sensing area 1052. The first capacitive sensing area 1051 is used for performing touch control detection, and the second capacitive sensing area 1052 is used for performing proximity detection rather than the touch control detection. Correspondingly, the controller 110 comprises a touch control detection circuit 1101 and a proximity detection circuit 1102. The touch control detection circuit 1101 is used for controlling the first capacitive sensing area 1051 to perform the touch control detection, and the proximity detection circuit 1102 is coupled to the touch control detection circuit 1101 and is utilized for controlling the second capacitive sensing area 1052 to perform the proximity detection. Specifically, the touch control detection circuit 1101 and proximity detection circuit 1102 are implemented within the controller 110 that has a single housing, e.g. a packaged integrated circuit chip. That is, in this embodiment, a single controller can be employed for concurrently performing both of the touch control detection and proximity detection. In addition, the proximity detection circuit 1102 is coupled to the touch control detection circuit 1101, and detection results of the touch control detection circuit 1101 and proximity detection circuit 1102 can be shared to each other.

The touch control detection circuit 1101 is connected to the first capacitive sensing area 1051 via multiple sense lines (multiple parallel sense lines and multiple vertical sense lines), and is used for executing the touch control detection. The touch control detection circuit 1101 is able to calculate capacitance change of the first capacitive sensing area 1051 of projective capacitive panel 105 to detect a position of a touch point by employing a self-capacitance sense calculation. In addition, by employing a mutual-capacitance sense calculation, the touch control detection circuit 1101 can also calculate the capacitance change of the first capacitive sensing area 1051 of projective capacitive panel 105 to detect the position of touch point. For the proximity detection, the proximity detection circuit 1102 is connected to the second capacitive sensing area 1052 via other wires, and is arranged to execute the proximity detection, to detect whether a user approaches the touch control apparatus 100. For example, if the touch control apparatus 100 is a smart phone, the capacitance value sensed by the second capacitive sensing area 1052 would be changed when the user picks up the smart phone, dials a number, and causes the smart phone approach a human hear. By detecting the change of sensed capacitance value, the proximity detection circuit 1102 can detect whether the user approaches the touch control apparatus 100. The proximity detection circuit 1102 is able to calculate capacitance change of the second capacitive sensing area 1052 of projective capacitive panel 105 to detect whether the user approaches the touch control apparatus 100 by employing a self-capacitance sense calculation. In addition, by employing a mutual-capacitance sense calculation, the proximity detection circuit 1102 can also calculate capacitance change of the second capacitive sensing area 1052 of projective capacitive panel 105 to detect whether the user approaches the touch control apparatus 100.

Additionally, if the touch control apparatus 100 is a smart phone, the panel 105 of touch control apparatus 100 may include other designs at its product appearance, e.g. the camera hole 1053 shown in FIG. 1. However, this is merely used for illustrative purposes for an embodiment of the touch control apparatus 100b being implemented by a smart phone device, and is not meant to be a limitation of the present invention. Additionally, in another embodiment, for the sake of saving more power, the second capacitive sensing area 1052 may be arranged to be enabled after the system of touch control apparatus 100 executes a specific function or operation. For instance, the corresponding operation of second capacitive sensing area 1052 is enabled when the system executes an audio communication function, and the corresponding operation is disabled when the system does not execute the audio communication function. By doing this, more power can be saved.

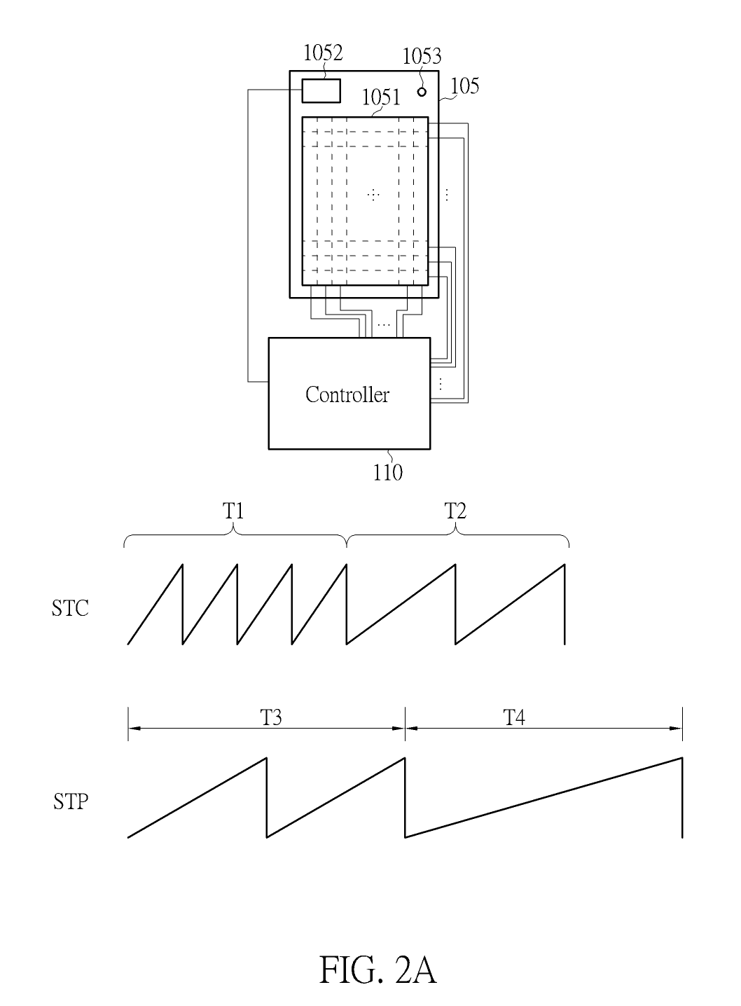

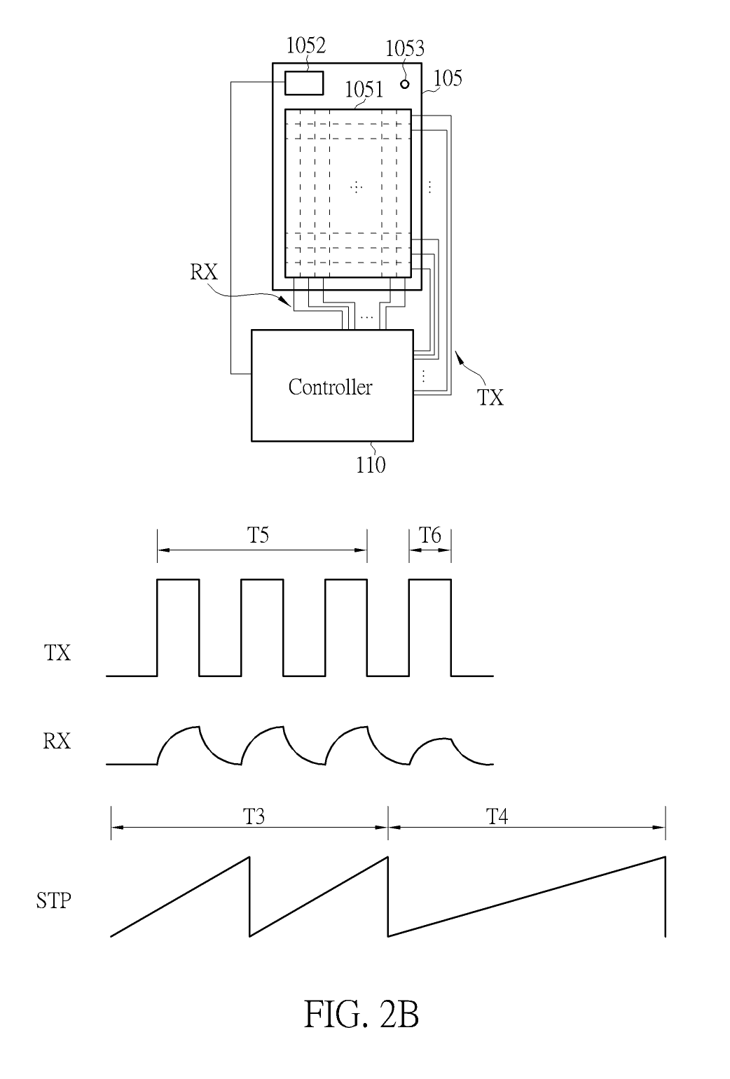

Please refer to FIG. 2A, which is a signal diagram illustrating the case which the touch control detection circuit 1101 as shown in FIG. 1 uses the self-capacitance sense calculation and the proximity detection circuit 1102 executes the proximity detection. As shown in FIG. 2A, when the touch control detection circuit 1101 of FIG. 1 is arranged to employ the self-capacitance sense calculation to calculate the capacitance change of first capacitive sensing area 1051 of projective capacitive panel 105 to detect the position of the touch point, the signal STC represents the signal timing obtained by the self-capacitance sense calculation used by the touch control detection circuit 1101. During a time period T1, the user does not touch the first capacitive sensing area 1051, and no finger capacitors due to parallel connection are generated. The capacitance value at the whole sensing line is smaller, and an RC time constant (the time constant to charge or discharge a capacitor through a resistor) is smaller. The speed for charging or discharging the capacitor through the resistor is faster. During a time period T2, the user touches the first capacitive sensing area 1051, and a finger capacitor due to parallel connection is generated. The capacitance value at the whole sensing line becomes greater, and the RC time constant becomes greater. The speed for charging or discharging the capacitor through the resistor becomes slower. Thus, by detecting the speeds for charging or discharging the capacitor through the resistor, the touch control detection circuit 1101 can detect or identify whether the user touches the first capacitive sensing area 1051 of touch control apparatus 100 and can detect the position of a touch point.

In addition, as shown in FIG. 2A, the proximity detection circuit 1102 is also able to sense the capacitance change to detect whether the user approaches the touch control apparatus 100. For instance, the signal STP represents the signal timing obtained by using a self-capacitance sense calculation to calculate the capacitance change of second capacitive sensing area 1052 of projective capacitive panel 105 to detect whether the user approaches the touch control apparatus 100. During a time period T3, the user does not approach the panel 105, and the capacitance value sensed by the second capacitive sensing area 1052 is smaller, and an RC time constant is smaller. The speed to charge or discharge a capacitor through a resistor is faster. During the time period T4, the user approaches to panel 105 so that the capacitance value sensed by the second capacitive sensing area 1052 becomes greater, and the RC time constant becomes greater. The speed to charge or discharge the capacitor through the resistor becomes slower. By detecting the speeds for charging or discharging the capacitor mentioned above, the proximity detection circuit 1102 is able to detect or identify whether the user currently approaches the second capacitive sensing area 1052 of touch control apparatus 100, to detect whether the user approaches the panel 105 or not.

In addition, in practice, the operations of touch control detection circuit 1101 and first capacitive sensing area 1051 can be designed to achieve the effects of higher resolution and higher frame rate so as to improve the accuracy of touch sensing control operation. The operations of proximity detection circuit 1102 and second capacitive sensing area 1052 are designed to achieve the effects of high sensibility, high stability, and low report rate, so as to be able to detect an object at a distance and improve the accuracy of the detection. The operation of increasing the sensibility to detect an object at a distance can be achieved by using an external capacitor having a greater capacitance value to make the time for charging/discharging be longer and increase the sensibility. In addition, since only a low report rate is required for the embodiment, other schemes can be used with the touch control apparatus 100 to prevent the signal from being interfered by noise. In another embodiment, the second capacitive sensing area 1052 can be integrated within an area of the first capacitive sensing area 1051, and can be used with an external capacitor having a greater capacitance value to increase the sensibility. In addition, for the sake of power saving, the second capacitive sensing area 1052 can be designed to be enabled or activated to detect the user approaches a screen of touch control apparatus 100 only when the system of touch control apparatus 100 executes a specific function or operation. The second capacitive sensing area 1052 is disabled or deactivated when the system of touch control apparatus 100 does not execute the specific function or operation. By doing this, the objective of power saving can be achieved.

Please refer to FIG. 2B, which is a signal diagram illustrating the case which the touch control detection circuit 1101 as shown in FIG. 1 uses the mutual-capacitance sense calculation and the proximity detection circuit 1102 executes the proximity detection. As shown in FIG. 2B, when the touch control detection circuit 1101 of FIG. 1 is arranged to employ the mutual-capacitance sense calculation to calculate the capacitance change of first capacitive sensing area 1051 of projective capacitive panel 105 to detect a position of the touch point, the signal TX represents a driving signal generated by the mutual-capacitance sense calculation employed by the touch control detection circuit 1101. For the first capacitive sensing area 1051 of panel 105, the sensing lines disposed horizontally are used as driving lines, and the sensing lines disposed vertically are used as sensing lines, when the mutual-capacitance sense calculation are applied. The signal TX represents driving line signals sequentially generated by the mutual-capacitance sense calculation. The signal RX represents sensing line signals correspondingly sensed due to the driving line signals indicated by the signal TX. During a time period T5, the user does not touch the first capacitive sensing area 1051, and no finger capacitors due to a serial connection are generated. Accordingly, the capacitance value is greater. Instead, during a time period T6, the user touches the first capacitive sensing area 1051, and a finger capacitor due to a serial connection is generated. The capacitance value becomes smaller. Based on the difference between the signals TX and RX, the touch control detection circuit 1101 can detect or identify whether the user currently touches the first capacitive sensing area 1051 of touch control apparatus 100.

In addition, as shown in FIG. 2B, the proximity detection circuit 1102 can detect whether the user approaches the touch control apparatus 100 by detecting the change of sensed capacitance value. For example, the signal STP represents employing a self-capacitance sense calculation to calculate the capacitance change of the second capacitive sensing area 1052 of projective capacitive panel 105 so as to detect whether the user approaches the touch control apparatus 100. In addition, in above embodiments, the proximity detection circuit 1102 utilizes a self-capacitance sense calculation to calculate the capacitance change of second capacitive sensing area 1052 of projective capacitive panel 105. That is, the touch control detection circuit 1101 and proximity detection circuit 1102 shown in FIG. 2A utilize different self-capacitance sense calculation to calculate the capacitance changes of first capacitive sensing area 1051 and second capacitive sensing area 1052, respectively. As shown in FIG. 2B, the touch control detection circuit 1101 and proximity detection circuit 1102 respectively utilize the self-capacitance sense calculation and mutual-capacitance sense calculation to calculate the capacitance changes of first capacitive sensing area 1051 and second capacitive sensing area 1052, respectively. However, in other embodiments, the proximity detection circuit 1102 can also use a mutual-capacitance sense calculation to calculate the capacitance change of second capacitive sensing area 1052 of projective capacitive panel 105. In other words, in other embodiments, the touch control detection circuit 1101 and proximity detection circuit 1102 can utilize different mutual-capacitance sense calculations to respectively calculate the capacitance changes of first capacitive sensing area 1051 and second capacitive sensing area 1052, and/or the touch control detection circuit 1101 and proximity detection circuit 1102 can respectively utilize the self-capacitance sense calculation and mutual-capacitance sense calculation to calculate the capacitance changes of first capacitive sensing area 1051 and second capacitive sensing area 1052. All these design modifications fall within the scope of the present invention.

Accordingly, by employing the second capacitive sensing area 1052 to perform the proximity detection operation, it is not required for the touch control apparatus 100 to perform the proximity detection operation by using an additional proximity detector. For example, it is not required for the touch control apparatus 100 to further use an additional infrared ray (IR) proximity detector. That is, for performing proximity detection, an operation of a conventional IR proximity detector is replaced by the operations of second capacitive sensing area 1052 and proximity detection circuit 1102 within the controller 110. Consequently, if the touch control apparatus 100 is a light-weight and portable electronic device, an advantage that the whole size of the portable electronic device is significantly decreased can be obtained by using the second capacitive sensing area 1052 and proximity detection circuit 1102 to replace the conventional IR proximity detector for executing proximity detection. In addition, since it is not required to drive a light-emitting device to emit IR light, correspondingly more power can be saved. In addition, it is not required for the touch control apparatus 100 to configure an IR light emitting hole for the conventional IR proximity detector, and thus the appearance of touch control apparatus 100 is more attractive.

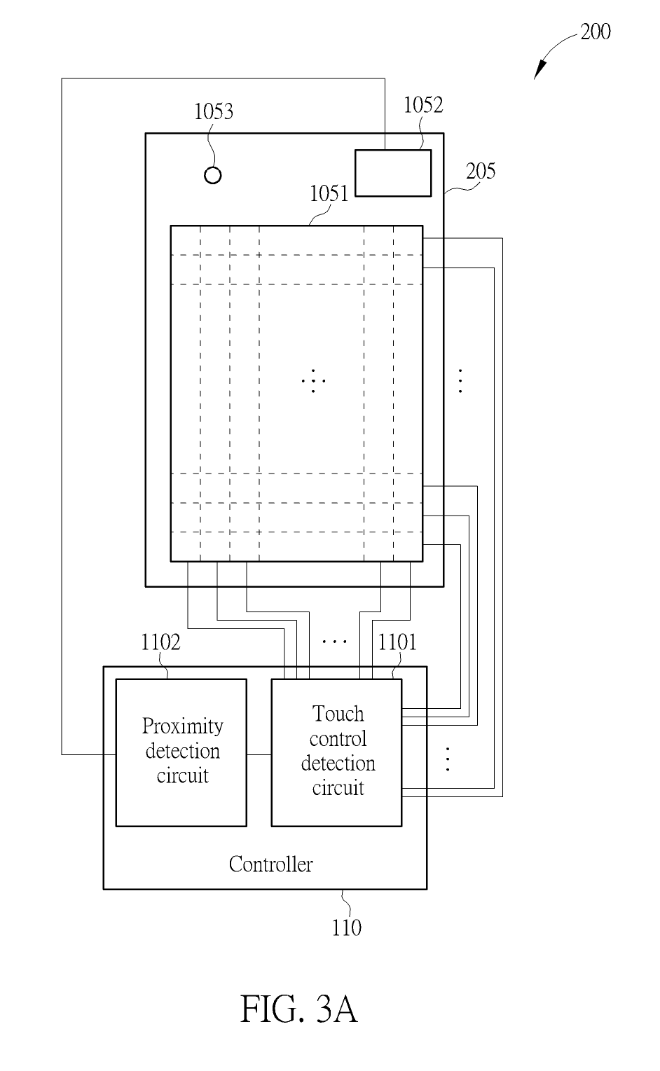

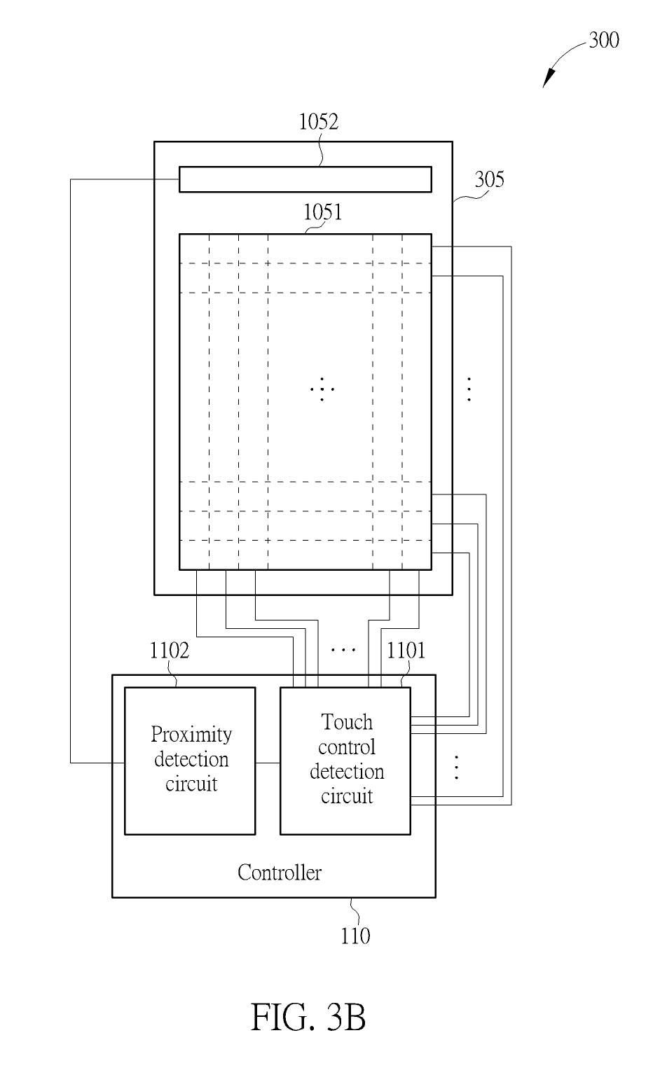

Furthermore, in practice, the second capacitive sensing area 1052 shown in FIG. 1 within the projective capacitive panel 105 is disposed at a left position above the first capacitive sensing area 1051. That is, as shown in the embodiment of FIG. 1, the second capacitive sensing area 1052 is disposed at the upper left corner of the projective capacitive panel 105. However, it should be noted that this embodiment is merely one of the embodiments and should be not intended to be a limitation of the invention. In other embodiments, the second capacitive sensing area 1052 can be disposed at any one position in the projective capacitive panel 105. Please refer to FIG. 3A and FIG. 3B. As shown in FIG. 3A, the second capacitive sensing area 1052 is disposed at a right position above the first capacitive sensing area 1051. That is, the second capacitive sensing area 1052 is disposed at the upper right corner of the projective capacitive panel 105. As shown in FIG. 3B, the second capacitive sensing area 1052 is disposed above the first capacitive sensing area 1051. Additionally, in other embodiments, the second capacitive sensing area 1052 may be disposed below the first capacitive sensing area 1051, at a right position below the first capacitive sensing area 1051, or at a left position below the first capacitive sensing area 1051. All these design modifications fall within the scope of the invention.

Further, in a preferred embodiment, the touch control apparatus 100 is designed as a portable electronic touch control apparatus such as a smart phone device. However, the touch control apparatus 100 is not merely limited to a portable device. The projective capacitive panel 105 and controller 110 mentioned above can be applied to other types electronic devices. In addition, the second capacitive sensing area 1052 mentioned above can be implemented using a transparent conducting oxide film formed by Indium Tin Oxide (ITO), a flexible print circuit (FPC), or a printed circuit board (PCB) . In other words, for the manufacturer process, both of the first capacitive sensing area 1051 and second capacitive sensing area 1052 can be implemented by coating the sensing areas 1051 and 1052 with the transparent conducting oxide film. If the sensing areas 1051 and 1052 are implemented using the transparent conducting oxide film, for the manufacturer process, at least one cell of the whole transparent conducting oxide film is used as the second capacitive sensing area 1052, and the other cells are used as the first capacitive sensing area 1051. Additionally, in another embodiment, the first capacitive sensing area 1051 can be implemented by coating the first capacitive sensing area 1051 with the transparent conducting oxide film while the second capacitive sensing area 1052 can be disposed on the PCB or on the FPC if the second capacitive sensing area 1052 is disposed on an opaque area of the panel 105. There are a variety of flexible implementations for the second capacitive sensing area 1052. All the design modifications fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch control apparatus, comprising:
a capacitive panel, comprising:
a first capacitive sensing area, for performing a touch control detection; and
a second capacitive sensing area, for performing a proximity detection, rather than performing the touch control detection;
a controller, coupled to the capacitive panel, for respectively controlling the first capacitive sensing area to perform the touch control detection and controlling the second capacitive sensing area to perform the proximity detection.

2. The touch control apparatus of claim 1, wherein the touch control apparatus is a portable touch control apparatus.

3. The touch control apparatus of claim 1, wherein a position of the second capacitive sensing area in the capacitive panel is configured above a position of the first capacitive sensing area.

4. The touch control apparatus of claim 1, wherein the controller is arranged to use a self-capacitance sense calculation to calculate capacitance change of the capacitive panel.

5. The touch control apparatus of claim 1, wherein the controller is arranged to use a mutual-capacitance sense calculation to calculate capacitance change of the capacitive panel.

6. The touch control apparatus of claim 1, wherein the second capacitive sensing area is implemented by a transparent conducting oxide film formed by indium tin oxide, a flexible print circuit, or a printed circuit board.

7. The touch control apparatus of claim 1, wherein the second capacitive sensing area is electronically isolated from the first capacitive sensing area.

8. A controller used in a touch control apparatus including a capacitive panel which includes a first capacitive sensing area and a second capacitive sensing area, the first capacitive sensing area being used for performing a touch control detection, the second capacitive sensing area being used for a proximity detection rather than performing the touch control detection, and the controller comprises:
a touch control detection circuit, for controlling the first capacitive sensing area to perform the touch control detection; and
a proximity detection circuit, coupled to the touch control detection circuit, for controlling the second capacitive sensing area to perform the proximity detection.

9. The controller of claim 8, wherein the touch control detection circuit uses a self-capacitance sense calculation to calculate capacitance change of the first capacitive sensing area of the capacitive panel, and the proximity detection circuit uses another self-capacitance sense calculation to calculate capacitance change of the second capacitive sensing area of the capacitive panel.

10. The controller of claim 8, wherein the touch control detection circuit uses a mutual-capacitance sense calculation to calculate capacitance change of the first capacitive sensing area of the capacitive panel, and the proximity detection circuit uses a self-capacitance sense calculation to calculate capacitance change of the second capacitive sensing area of the capacitive panel.

11. The controller of claim 8, wherein the second capacitive sensing area on the capacitive panel is electrically isolated from the first capacitive sensing area.

12. A controlling method used in a touch control apparatus including a capacitive panel which includes a first capacitive sensing area and a second capacitive sensing area, the first capacitive sensing area being used for performing a touch control detection, the second capacitive sensing area being used for a proximity detection rather than performing the touch control detection, and the controlling method comprises:
performing a touch control detection to control the first capacitive sensing area to execute the touch control detection; and
performing a proximity detection to control the second capacitive sensing area to execute the proximity detection.

13. The controlling method of claim 12, wherein the step of performing the touch control detection comprises:
using a self-capacitance sense calculation to calculate capacitance change of the first capacitive sensing area of the capacitive panel; and
the step of performing the proximity detection comprises:
using another self-capacitance sense calculation to calculate capacitance change of the second capacitive sensing area of the capacitive panel.

14. The controlling method of claim 12, wherein the sep of performing the touch control detection comprises:
using a mutual-capacitance sense calculation to calculate capacitance change of the first capacitive sensing area of the capacitive panel; and
the step of performing the proximity detection comprises:
using a self-capacitance sense calculation to calculate capacitance change of the second capacitive sensing area of the capacitive panel.

15. The controlling method of claim 12, wherein the second capacitive sensing area on the capacitive panel is electrically isolated from the first capacitive sensing area.
